(19) United States
(12) Patent Application Publication
(10) Pub. No.: US 2003/0208464 A1
(43) Pub. Date: Nov. 6, 2003

(54) System and method for optimizing log usage for temporary objects

(75) Inventors: Jesse Lee, Toronto (CA); Michael J. Winer, Markham (CA); Roger Luo Quan Zheng, Scarborough (CA)

Correspondence Address: Samuel A. Kassatly, Law Office, 6819 Trinidad Drive, San Jose, CA, 95120-2056, US

(73) Assignee: International Business Machines Corporation, Armonk, NY

(21) Appl. No.: 10/342,605

(22) Filed: Jan. 14, 2003

(30) Foreign Application Priority Data
May 2, 2002 (CA) 2,370,601

(51) Int. Cl. G06F 17/30

(52) U.S. Cl. 707/1

(57) ABSTRACT

A method and an associated apparatus manage log records during rollback of a group of changes within a unit of work in a database system, by distinguishing between temporary and permanent objects when creating log records. Log records associated with temporary objects are limited to those records that are required to support the rollback of changes made to the temporary table objects. Advantageously, log space consumption and reservation may be reduced, and performance may be improved by reducing the number of and content of log records written to a log.

### PRIORITY CLAIM

The present application claims the priority of Canadian Patent Application Serial No. 2,370,601, titled “Optimizing Log Usage For Temporary Objects,” Docket No. CA9-2001-0046, filed on Feb. 5, 2002, which is incorporated herein by reference in its entirety.

### FIELD OF THE INVENTION

The present invention generally relates to database management systems, and in particular to the management of logs in such systems.

### BACKGROUND OF INVENTION

A database management system (DBMS) will typically log the changes it makes to database objects so that it is capable of being able to undo, recover or roll forward such changes. In order to undo a change the DBMS maintains log information sufficient to permit the change performed on the database object to be reversed. In order to redo a change the DBMS maintains log information sufficient to permit the change performed on the database object to be repeated (for example, in the event of a system crash).

Some DBMSs use a write-ahead recovery model in which changes to data objects are logged before the changes are actually made to the objects. In order to support data recovery and rollback, many database log managers use compensation log records and backward log chaining to ensure that no attempt is made to undo actions that have been previously undone already. During rollback (i.e., undo) processing a compensation log record is written which logs the undo changes made to the database object.

Database objects can be broadly categorized as temporary or permanent. Temporary objects exist only while the database is active and only between the time they are created and dropped. They do not survive a database shutdown, whether such shutdown occurs normally or abnormally. Permanent objects are persistent and survive database shutdown. Accordingly, while permanent objects require undo and redo support, temporary objects only require undo support.

Many DBMSs do not distinguish between permanent and temporary objects when creating log records, with the result that unneeded records are created in connection with temporary objects. As space for creating log records is generally reserved space, such DBMSs require space to be reserved in anticipation of such unneeded records, regardless of whether they are even created during a session.

Accordingly, what is needed is a system that addresses, at least in part, the foregoing and other shortcomings.

### SUMMARY OF INVENTION

An aspect of the present invention is to provide a database log management system and associated method that distinguish between temporary and permanent objects when creating log records which reduces the types of log records, contents of log records and log space reservation created in connection with temporary objects.

Another aspect of the present invention is to provide a method and system in which log records associated with temporary objects are limited to those records that are required to support the rollback of changes made to the temporary table objects. Advantageously, log space consumption and reservation may be reduced, and performance may be improved by reducing the number of and content of log records written to a log.

According to yet another aspect of the invention there is provided a method for managing log records for temporary objects during rollback of a group of changes to temporary and permanent objects within a unit of work in a database system comprising determining for each change being rolled back if the change was performed on a temporary database object and for each change that was performed on a temporary database object, assessing if a compensation record is desired based on predetermined criteria, and selectively creating, based on the assessment, an associated compensation log record indicating that the change to the temporary object has been rolled back.

In a preferred embodiment, for each change performed on a temporary database object, an associated compensation log record indicating that the change to the temporary object has been rolled back is created only if the change is the last change to a temporary object to be rolled back in the group of changes. In another preferred embodiment, for each change that was performed on a temporary database object, an associated compensation log record indicating that the change has been rolled back is created only if the change is the last change to be rolled back in the group of changes.

The present invention further provides a method for managing log records associated with changes made to database objects in a database system, comprising reserving storage space for a compensation log record when creating a log record to log a change to a permanent database object, and selectively reserving storage space for a compensation log record when creating a log record to log a change to a temporary database object only if the change meets predetermined criteria, such that relatively less storage space for compensation log records for changes to temporary database objects is reserved than for compensation log records for changes to permanent database objects.

According to a further aspect of the invention, there is provided a computer program product and comprising a signal-bearing medium having computer readable code means for managing log records for temporary objects during rollback of a group of changes to temporary and permanent objects within a unit of work in a database system.

The computer readable code means includes code means for determining for each change being rolled back if the change was performed on a temporary database object and assessing code means for assessing for each change that was performed on a temporary database object if a compensation record is desired based on predetermined criteria, and selectively creating, based on the assessment, an associated compensation log record indicating that the change to the temporary object has been rolled back.

According to still a further aspect of the invention, there is provided an apparatus for managing log records in a database system, including at least one storage for electronically storing log records, database storage for electronically storing permanent database objects and temporary database objects, and log manager means for managing the creation of compensation log records during rollback of a group of changes within a unit of work in the database system. The log manager means includes: (i) means for determining for each change being rolled back if the change was performed on a temporary database object or a permanent database object; (ii) code means for creating and storing for each change that was performed on a permanent database object an associated compensation log record indicating that the change has been rolled back; and (iii) assessing means for assessing for each change that was performed on a temporary database object if a compensation record is desired based on predetermined criteria, and selectively creating and storing, based on the assessment, an associated compensation log record indicating that the change to the temporary object has been rolled back.

Other aspects and features of the present invention will become apparent to those ordinarily skilled in the art upon review of the description of specific embodiments of the invention in conjunction with the accompanying figures.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a high level block diagram of a database system according to the present invention;

FIG. 2 is a process flowchart illustrating a method used by the database system of FIG. 1, for creating log records to track a change to a database object;

FIG. 3 shows an exemplary format for a log record;

FIG. 4 is a process flowchart illustrating an operation sequence for creating log file records during undo processing according to an embodiment of the present invention; and

FIG. 5 is a process flowchart illustrating an operation sequence for creating log file records during undo processing according to another embodiment of the present invention.

### DESCRIPTION OF PREFERRED EMBODIMENTS

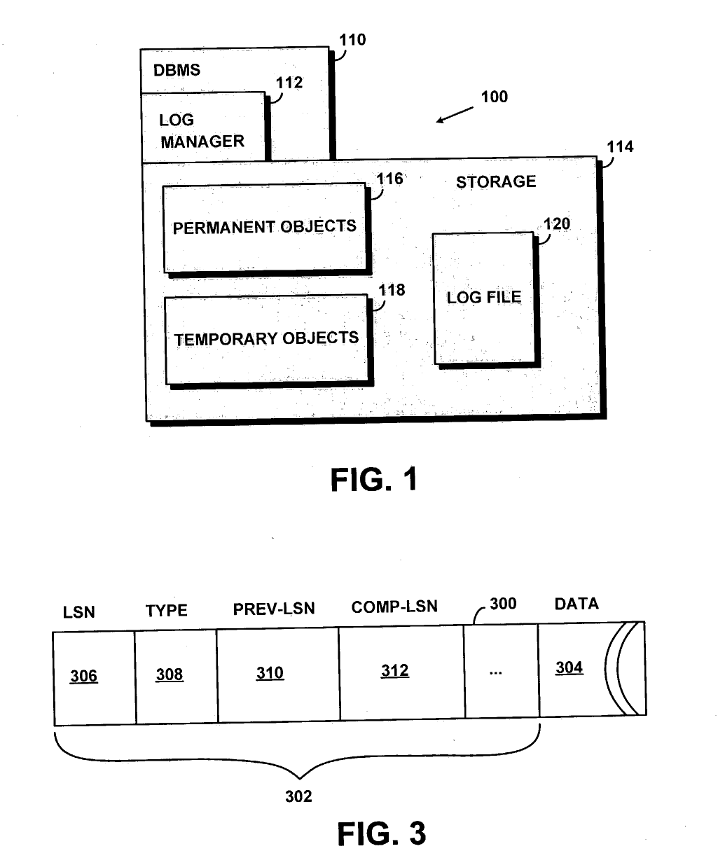

Referring to FIG. 1, a conceptual block diagram illustrating a database system 100 according to a preferred embodiment of the invention is shown. The database system 100 includes a database management system (DBMS) 110 implemented by a software or algorithm that is executed by a processor that manages the creation, modification, access, and deletion of data tables or objects that are stored in a database storage 114. The data objects include permanent objects 116 that include for example persistent tables, and other data objects that are intended to survive in the storage 114 on shutdown of the database system. The data objects also include temporary objects 118 that include for example non-persistent tables and other data objects that are not intended to survive a system shutdown, whether such shutdown occurs normally or abnormally. The storage 114 can include a number of storage devices of different types.

The DBMS 110 includes a log manager 112 that maintains a log 120 in a persistent storage location to record information necessary for supporting undo and redo operations as may be required in connection with the permanent and temporary objects 116, 118. One aspect of the present invention relates to the maintenance of the log 120 by the log manager 112.

The log 120 contains a series of log records that represent a sequential, time-ordered list of events that occur in connection with both permanent objects 116 and temporary objects 118. Each of the log records has a header that includes a unique identifying log sequence number (LSN). The database system 100 can be shared among a number of users performing a number of different database transactions at any given time, each transaction including a number of different events that each have a log record associated therewith.

By way of background, the changes that are effected in connection with a single database transaction are collectively a unit of work (UOW). A database transaction is the work that occurs between the beginning of a UOW and a commit or abort. A transaction is “committed” when there is some guarantee that all the effects of the transaction are stable in persistent storage. A transaction is “aborted” when the transaction ends, either through an intentional intervention or through an unintentional act such as a system crash, prior to the transaction being committed.

In the event that the transaction is aborted, then the changes that have been made to the database in connection with the transaction must be rolled back. The phrases “undo” and “roll-back” are used interchangeably herein, as are the phrases “change” and “action” in the context of changes, and actions performed on database objects.

In log 120, log records for events associated with a given transaction may be interspersed among log records for other transactions, rather than be consecutively recorded. As known in the art, backward chaining is used to group all the log records associated with a single transaction in that the header for each log record (other the first log record for the first event in a transaction) includes a field that indicates the LSN of the previous log record associated with the subject transaction.

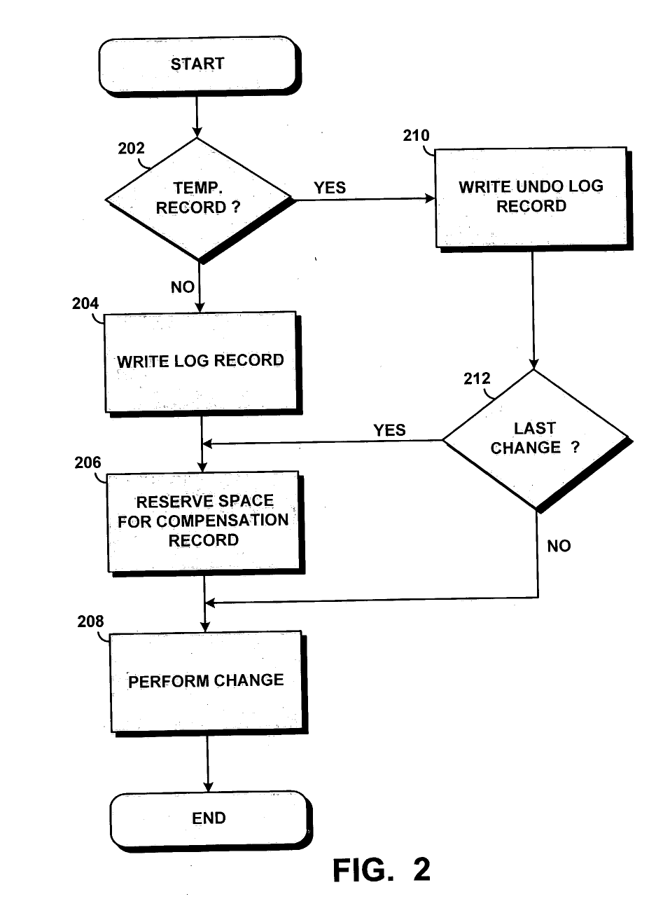

With reference to FIG. 2, a simplified flow chart 200 showing the steps performed by the management system, DBMS, 110 in connection with logging changes to a data object is illustrated according to a preferred embodiment of the present invention. When an event or change in connection with a data object is requested, the log manager 112 determines whether the data object on which the change is being effected is a permanent object or a temporary object (step 202). If the change is being performed in connection with a permanent object, conventional log management steps are performed, including the writing of a log record to the log file 120 (step 204).

The types of log records written in connection with permanent objects may include for example: REDO only records, UNDO only records, NORM records, and log compensation records. REDO records are used to record information about changes that will permit the specific operations which took place during those changes to be repeated. Generally, those operations will need to be repeated during a recovery or roll-forward scheme. UNDO records are used to record information permitting operations on data objects to be rolled back correctly. UNDO records are used to restore blocks to conditions existing when a transaction began. NORM records are combined REDO and UNDO records in that they contain information necessary for both recovery and rollback operations, and are used place of separate REDO and UNDO records in connection with a change.

With reference to FIG. 3, an exemplary log record format 300 is shown that includes a header field 302 and a data field 304. The header field 302 includes a unique identifying log sequence number (LSN) attribute 306, and a backward chaining LSN attribute PREV-LSN 310 for chaining to the previous change associated with a transaction.

The header field 302 also includes a type attribute 308 that identifies the log record type, for example as a REDO, UNDO, NORM or log compensation record. The header field 302 may also include for example, attributes that identify the transaction that the log record is associated with, and other information describing the nature of the change, in order to permit it to be redone (in a REDO or NORM record) or rolled back (in an UNDO or NORM record), such as identification of the number of and location of the records in the subject data object that were affected by the change.

In the event that the actual data added to, or removed from the data object by the change is required, it is stored in the data field 304. For example, if the change was an “insert”, then in a REDO only log record the actual data inserted would be stored in data field 304. For an UNDO only log record, the actual data inserted would not be needed, as the header 302 would identify what records in the subject data object had been added, thus permitting the so identified fields to be deleted in the event of a rollback. Conversely, if the change was a “delete”, then the actual data deleted would be required in the data field 304 of an associated UNDO log record, but would not be required in the data field of an associated REDO log record. As NORM records support both UNDO and REDO activities, the actual data inserted or deleted would be required in the data field 304 of an associated NORM log record.

Turning to FIG. 2, in addition to writing the appropriate log record(s) to log a change to permanent object (step 204), the log manager 112 also reserves space in the log file 120 for a compensation record to be written in connection with the logged change in the event that the change that is being logged is rolled back at sometime in the future. The compensation log records and the backward log chaining are used by the log manager 112 to manage undo actions in connection with permanent objects, in order to avoid attempts to undo changes that have already been undone.

As it will be explained below, during undo processing, compensation log records are written to log the undo changes made to the database object. Compensation log records contain a further header attribute (represented as COMP-LSN 312 in FIG. 3) containing the LSN of the log record written by the UOW immediately preceding the log record of the change that is being undone.

When the DBMS 110 encounters a compensation log record during undo processing, it indicates that the action has already been undone, including all undoable actions which followed the original action. In the process represented in FIG. 2, once the compensation record log space has been reserved (step 206) the DBMS 110 effects the requested change (step 208).

In order to reduce the amount and frequency of data written to the log 120, the log manager 112 of the present invention distinguishes, as indicated above, between temporary and permanent objects (step 202). In particular, the log manager 112 does not write REDO log records or NORM log records in connection with changes to temporary objects, but only writes UNDO records (step 210) in recognition of the fact that redo support is not required for temporary objects.

Additionally, the log manager 112 flags the log records that it generates in connection with temporary objects as records that pertain to temporary objects. By way of example, such flagging may be done by setting a bit in the type attribute 308 when writing the UNDO record. If the change to a temporary object that is being logged is a “delete”, then the actual data deleted is stored in the data field 304 of the associated log record 300. If the change is an “insert”, then the actual data is not required, and so the data field 304 may be truncated or removed entirely from the record 300.

As it will be explained in greater detail later, during undo or roll-back processing, according to preferred embodiments of the present invention, compensation log records are not generally written for each event or change that is rolled-back for temporary objects. Rather, at most a single special compensation or black-out free record (the terms “compensation record” and “black-out free record” are used interchangeably herein) is used for the group of changes or events that is rolled back by an undo process.

Generally, an undo process will roll-back either an entire UOW, or will roll-back a subset of a UOW as identified by a savepoint that has either been user defined, or defined by the DBMS 110 based on pre-defined rules. A savepoint is used to permit selected changes within a transaction to be undone. Thus, according to the present invention when logging an undo log record in connection with a temporary table, the log manager 112 needs only reserve space in the log file 120 once for a compensation record for each such “group” of changes.

In the present exemplary embodiment, the log manager accomplishes this by only reserving compensation log record space for the group of changes when it recognizes that it has reached the last log-able change associated with a temporary object within a group of undoable steps (step 212). After writing an undo log record in connection with the subject change, and reserving space for a special compensation record in the event that the subject change is the last change pertaining to a temporary object in UOW or a savepoint defined subset of changes, the requested change is performed (step 208).

In preferred embodiments of the present invention, when performing recovery or roll forward operations, the DBMS 110 ignores any records in the log 120 that are flagged as pertaining to temporary objects. As it is possible that multiple rollback operations can still be performed in connection with a temporary data object, a method for tracking undo actions is required in the absence of the compensation log records that are used in connection with permanent objects.

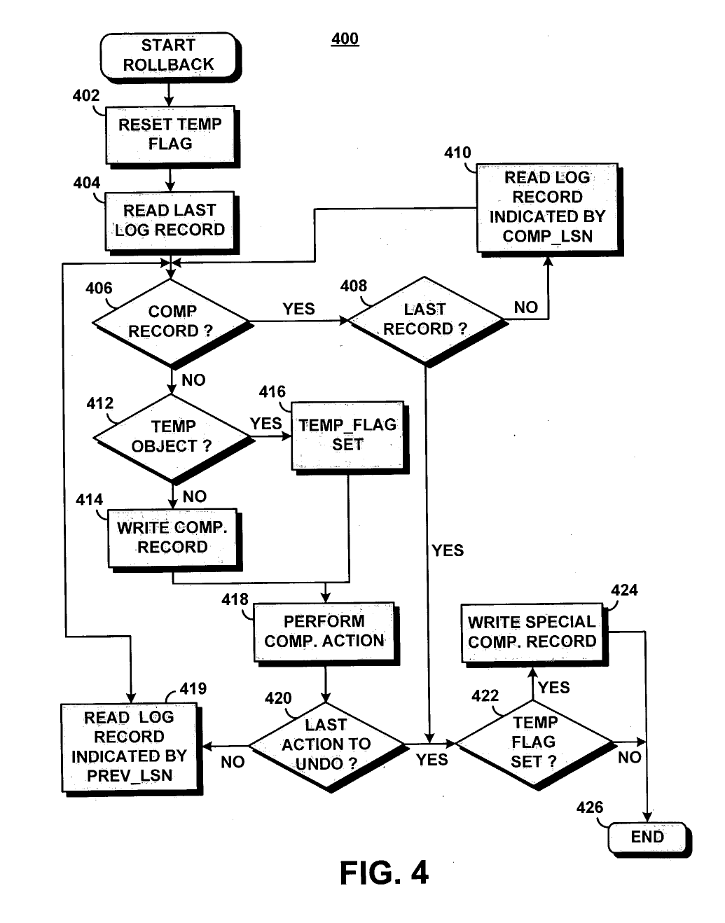

A method 400 illustrating the steps taken by the log manager 112 during undo processing in accordance with embodiments of the present invention is illustrated in FIG. 4. As indicated above, changes to be rolled back will generally be grouped as an entire UOW, or as a sub-set of the UOW as defined by a savepoint.

At the commencement of rollback, a “TEMP_FLAG” is reset (step 402). Such flag is used by the log manager 112 to indicate when a change in connection with a temporary file has been performed during the subject rollback. The log record for the last change made in the sequence of changes to be rolled back is then read (step 404), and its type attribute 308 is checked to determine if the log record is a compensation log record (step 406).

If at decision step 406 method 400 determines that the log record is not a compensation log record, a check is made to determine if the log record is for a change associated with a change to temporary object or a permanent object (step 412). If the log record relates to a permanent object, then a compensation log record is written (step 414) to support undo/redo processing in connection with the change that is being undone.

The COMP-LSN 312 attribute of the compensation record is set to point to the LSN of the log record in the UOW that is previous to the log record of the change that is to be rolled back, unless the change being rolled back is the last change in the UOW to be rolled back (in other terms, the first change in the OUW), in which case the COMP-LSN 312 is set to a null value. Once the compensation record has been written, the compensation action is performed (i.e., the change identified in the subject log record is undone—step 418).

If at decision step 412 it is determined that the log record pertains to a change to a temporary object, step 414 of writing a compensation record is skipped, and instead the TEMP_FLAG is set to indicate that a log record in connection with a temporary object has been encountered during the roll back process (step 416), after which the compensation action required to undo the change associated with the subject log record is performed (step 418).

A determination is then made if the change that is being undone is the last change to be undone in connection with the undo process (step 420). A null value in the PREV-LSN attribute 312 indicates that the subject log record is the first log record in the UOW, and thus associated with the last action to be rolled back in the UOW. In the event that roll-back is being performed back to a savepoint, a PREV-LSN value that points to the LSN of a log record prior to the savepoint indicates that the last action in the rollback has been reached.

In the event that more changes need to be rolled back, the PREV-LSN is used to read the log record for the next change to be rolled back (step 419), and the process repeated commencing at step 406.

If at decision step 420 it is determined that the last change in the rollback has been undone, then a determination is made by checking the value of TEMP_FLAG if any changes to temporary objects were rolled back during the rollback process (step 422). If so, then a special compensation record is written to the log file 120 in order to ensure that future rollbacks won't result in attempts to undo events in connection with temporary objects that have already been undone.

The COMP-LSN attribute of the special compensation record is set to point to the LSN of the log record associated with the last event that occurred prior to the events rolled back by the subject undo process, that is when a rollback to a savepoint is performed, the last event prior to the savepoint. In the event that all events in a UOW have been undone, then the COMP-LSN will be set to a null value.

The situation will now be considered if a compensation log record is detected at decision step 406. If a compensation log record is detected during rollback, the log manager 112 determines if the compensation record is the last record in the undo sequence (step 408) by checking the COMP-LSN attribute 312. A null value in the COMP-LSN attribute 312 indicates that the subject log record is the first compensation log record for a UOW, and therefore the last in the rollback of an UOW.

In the event that rollback is being performed back to a savepoint, a COMP-LSN value that points to the LSN of a log record prior to the savepoint indicates that the subject log record is the last compensation log record in the rollback. In the event that the compensation record is the last log record to be considered during the roll back process, then the log manager advances to decision step 422 to determine if the temp flag has been set, and if so a special compensation record is written (step 424) as described above (step 426).

If at decision step 408 it is determined that the compensation record is not the last log record to be considered, the log record indicated by the COMP-LSN attribute is read (step 410) and the process continues at step 406.

It will thus be appreciated that according to the present invention, undo logging activities are different for temporary and permanent objects in that when a roll-back of a group of actions pertaining to one or more temporary objects is performed, the log manager 112 writes only one compensation log record to the log file 120 in connection with the group, rather than writing a compensation log record for every change in the group that pertains to a temporary object. As a result, fewer compensation log records are required to be written during undo processing, which in turn means that less space needs to be reserved for compensation log records when the changes are originally performed (as discussed above in connection with the change process 200 of FIG. 2).

Additionally, when database changes are originally logged, the log manager 112 distinguishes between changes to temporary and permanent objects to only write UNDO records for temporary objects, which can result in shorter records as UNDO log records do not need to include, in the case of an insert, a copy of the data that has been inserted. The reductions in the size and number of log records written, and the reduced reservation space achieved by the present invention can be significant when several different users are using the database system 100.

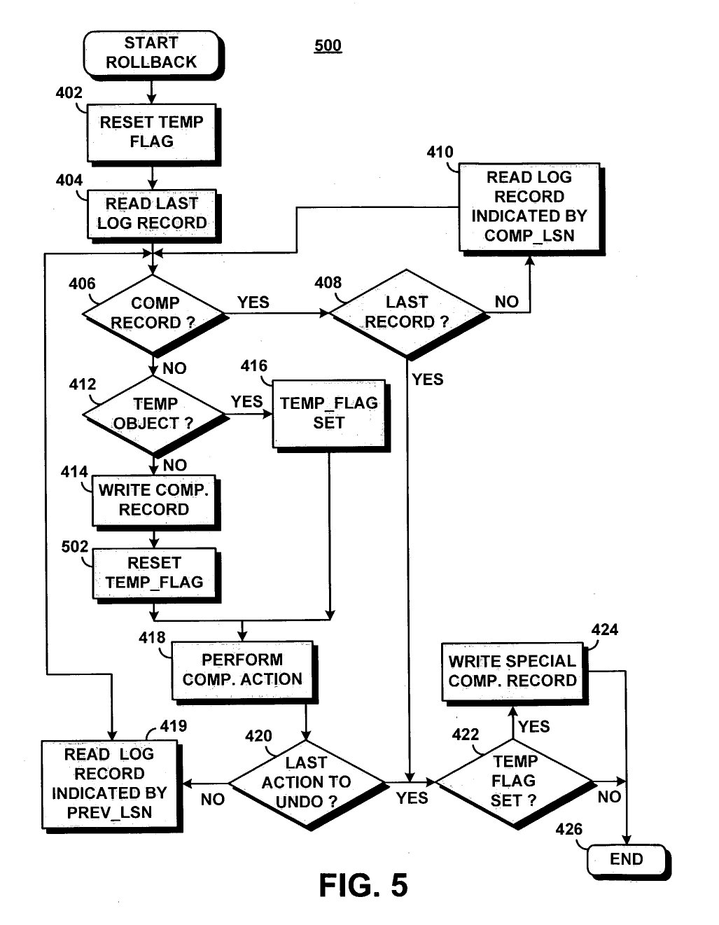

In another embodiment of the invention, the number of compensation records written in connection with temporary objects during undo processing is further reduced. With reference to FIG. 5, a process 500 implemented by the log manager 112 during undo processing in accordance with further embodiments of the present invention is shown. Process 500 is generally similar to process 400, except that the variable TEMP_FLAG is used to indicate if the last change rolled back was on a temporary object, rather than to indicate if any rolled back changes were on a temporary object.

In this regard, if the log manager 112 determines, when considering a subject non-compensation log record during a roll back, that the subject record pertains to a permanent object (step 412), then the variable TEMP_FLAG is reset to its default value (step 502) to indicate that the most recent log record considered by the system pertained to a permanent object. As a result, if the last change to be rolled back in the roll-back sequence pertains to a permanent object, then the log manager 112 will determine at step 422 that the TEMP_FLAG is not set, and will end the undue process without writing a special compensation log record (i.e., without performing step 424) even if the roll-back included roll-back of a change to a temporary object.

Thus, in the undo process 500, the writing of a special compensation log (step 424) will only occur if the last action to be undone during the undo process was a change in connection with a temporary object. It will be appreciated that this result could be accomplished with a logic flow other than that shown in FIG. 5. For example, a process that did not use a flag such as TEMP_FLAG but rather, in place of step 416, includes a step of determining if the subject change to a temporary files was the last action to be rolled-back, and if so, then write the special compensation record.

Although the database system 100 has been illustrated in FIG. 1 as having single log file 120 to which all log records are written, a variety of different log file configurations could be used. For example, separate log files could be used for log records pertaining to permanent objects than for log records pertaining to temporary objects.

The log management functions of the present invention may be implemented using one or more processors executing suitable program code. The program code may be stored or transmitted using various signal carrying storage and transmission mediums known in the art, including for example optical storage mediums, magnetic storage mediums, electrical transmission mediums, and optical transmission mediums.

While the present invention has been shown and described with reference to certain embodiments thereof, it will be understood by those skilled in the art that the forgoing and other changes in forma and details may be made to the described embodiments without departing from the spirit and scope of the invention.

What is claimed is:

1. A method for managing log records for temporary objects during rollback of a group of changes to temporary objects and permanent objects within a unit of work, comprising:
for each change being rolled back determining if the change was performed on a temporary object;
for each change that was performed on a temporary object, assessing if a compensation record is desired; and
based on an assessment of the change to the temporary object, selectively creating an associated compensation record indicating that the change to the temporary object has been rolled back.

2. The method of claim 1, wherein if the change to the temporary object is a last change to a temporary object to be rolled back in the group of changes, creating an associated compensation record for each change that was performed on the temporary object, to indicate that the change to the temporary object has been rolled back.

3. The method of claim 2, wherein the group of changes comprises changes made in a unit of work back to a defined savepoint.

4. The method of claim 3, wherein the compensation record comprises a pointer to a log record for a change in a unit of work immediately preceding the change associated with the compensation record.

5. The method of claim 1, wherein if the change to the temporary object is a last change to any object to be rolled back in the group of changes, creating an associated compensation record indicating that the change has been rolled back.

6. The method of claim 5, wherein the group of changes comprises changes made in a unit of work back to a defined savepoint.

7. The method of claim 6, wherein the compensation record comprises a pointer to a log record for a change in a unit of work immediately preceding the change associated with the compensation record.

8. The method of claim 1, wherein a plurality of compensation records associated with changes rolled back on temporary objects are stored sequentially in the same log file as compensation records associated with permanent objects.

9. The method of claim 1, wherein a plurality of compensation records associated with changes rolled back on temporary objects are stored in a first log file that is different than a log file in which compensation records associated with changes rolled back on permanent objects are stored.

10. The method of claim 1, further comprising:
reserving a storage space for a compensation record when creating a log record, in order to log a change to a permanent object; and
selectively reserving a storage space for a compensation record when creating a log record, in order to log a change to a temporary object, only if the change meets predetermined criteria, such that relatively less storage space for compensation records for changes to temporary objects is reserved than for compensation records for changes to permanent objects.

11. A computer program product having instruction codes for managing log records for temporary objects during rollback of a group of changes to temporary objects and permanent objects within a unit of work, comprising:
a first set of instruction codes which, for each change being rolled back, determines if the change was performed on a temporary object;
a second set of instruction codes which, for each change that was performed on a temporary object, assesses if a compensation record is desired; and
a third set of instruction codes which, based on an assessment of the change to the temporary object, selectively creates an associated compensation record indicating that the change to the temporary object has been rolled back.

12. The computer program product of claim 11, wherein if the change to the temporary object is a last change to a temporary object to be rolled back in the group of changes, the third set of instruction codes creates an associated compensation record for each change that was performed on the temporary object, to indicate that the change to the temporary object has been rolled back.

13. The computer program product of claim 12, wherein the group of changes comprises changes made in a unit of work back to a defined savepoint.

14. The computer program product of claim 13, wherein the compensation record comprises a pointer to a log record for a change in a unit of work immediately preceding the change associated with the compensation record.

15. The computer program product of claim 11, wherein if the change to the temporary object is a last change to any object to be rolled back in the group of changes, the third set of instruction codes creates an associated compensation record indicating that the change has been rolled back.

16. The computer program product of claim 15, wherein the group of changes comprises changes made in a unit of work back to a defined savepoint.

17. The computer program product of claim 16, wherein the compensation record comprises a pointer to a log record for a change in a unit of work immediately preceding the change associated with the compensation record.

18. The computer program product of claim 11, wherein a plurality of compensation records associated with changes rolled back on temporary objects are stored sequentially in the same log file as compensation records associated with permanent objects.

19. The computer program product of claim 11, wherein a plurality of compensation records associated with changes rolled back on temporary objects are stored in a first log file that is different than a log file in which compensation records associated with changes rolled back on permanent objects are stored.

20. The computer program product of claim 11, further comprising a fourth set of instruction codes that reserves a storage space for a compensation record when creating a log record, in order to log a change to a permanent object, and that selectively reserves a storage space for a compensation record when creating a log record, in order to log a change to a temporary object, only if the change meets predetermined criteria, such that relatively less storage space for compensation records for changes to temporary objects is reserved than for compensation records for changes to permanent objects.

21. A system for managing log records for temporary objects during rollback of a group of changes to temporary objects and permanent objects within a unit of work, comprising:
means for determining whether each change being rolled back was performed on a temporary object;
for each change that was performed on a temporary object, means for assesses if a compensation record is desired; and
means for selectively creating an associated compensation record based on an assessment of the change to the temporary object, wherein the associated compensation record indicates that the change to the temporary object has been rolled back.

22. The system of claim 21, wherein if the change to the temporary object is a last change to a temporary object to be rolled back in the group of changes, the means for selectively creating creates an associated compensation record for each change that was performed on the temporary object, to indicate that the change to the temporary object has been rolled back.

23. The system of claim 22, wherein the group of changes comprises changes made in a unit of work back to a defined savepoint.

24. The system of claim 23, wherein the compensation record comprises a pointer to a log record for a change in a unit of work immediately preceding the change associated with the compensation record.

25. The system of claim 21, wherein if the change to the temporary object is a last change to any object to be rolled back in the group of changes, the means for selectively creating creates an associated compensation record indicating that the change has been rolled back.

26. The system of claim 25, wherein the group of changes comprises changes made in a unit of work back to a defined savepoint.

27. The system of claim 26, wherein the compensation record comprises a pointer to a log record for a change in a unit of work immediately preceding the change associated with the compensation record.

28. The system of claim 21, wherein a plurality of compensation records associated with changes rolled back on temporary objects are stored sequentially in the same log file as compensation records associated with permanent objects.

29. The system of claim 21, wherein a plurality of compensation records associated with changes rolled back on temporary objects are stored in a first log file that is different than a log file in which compensation records associated with changes rolled back on permanent objects are stored.

30. The system of claim 21, further comprising:
means for reserving a storage space for a compensation record when creating a log record, in order to log a change to a permanent object; and
means for selectively reserving a storage space for a compensation record when creating a log record, in order to log a change to a temporary object, only if the change meets predetermined criteria, such that relatively less storage space for compensation records for changes to temporary objects is reserved than for compensation records for changes to permanent objects.
